(19) United States
(12) Patent Application Publication
(10) Pub. No.: US 2025/0282543 A1
(43) Pub. Date: Sep. 11, 2025

(54) EMESIS CONTAINMENT SYSTEM, METHOD OF USE, AND DISSOLVABLE CHARGE THEREFOR

(71) Applicant: Purdue Research Foundation, West Lafayette, IN (US)

(72) Inventors: Kendra Erk, West Lafayette, IN (US); Robert Gold, Newburgh, IN (US); Ethan Francoeur, Mount Laurel, NJ (US); Logan Mick, Parker City, IN (US); Jae Hong Park, West Lafayette, IN (US); Akul Nimish Seshadri, Woodbury, MN (US); Parth Kelkar, West Lafayette, IN (US); Subin Han, West Lafayette, IN (US)

(21) Appl. No.: 19/074,760

(22) Filed: Mar. 10, 2025

Related U.S. Application Data
(60) Provisional application No. 63/563,724, filed on Mar. 11, 2024.

(51) Int. Cl. B65F 1/00; B65F 1/16

(52) U.S. Cl. CPC B65F 1/0026; B65F 1/1607; B65F 2210/1026; B65F 2210/129; B65F 2240/172

(57) ABSTRACT

Emesis containment systems, methods of use, and dissolvable charges therefor. Such an emesis containment system includes a face mask, a container for receiving vomit, an air filter, a backflow barrier to inhibit passage of vomit out of the container, and a dissolvable charge disposed inside the container. The dissolvable charge includes a surfactant that foams when contacted by liquid of the vomit. The surfactant forms a foam barrier on a top surface of the vomit inside the container to inhibit escape of gases from the vomit from the container. The dissolvable charge includes a dry pressed pellet having dry powder forms of a surfactant, absorbent particles, and a thickening agent pressed together. At least some of each of the surfactant, the absorbent particles, and the thickening agent is disposed on an exterior surface dry pressed pellet.

### CROSS-REFERENCE TO RELATED APPLICATIONS

This application claims the benefit of provisional U.S. Patent Application No. 63/563,724 filed Mar. 11, 2024, the contents of which are incorporated herein by reference.

### BACKGROUND OF THE INVENTION

The invention generally relates to emesis containment systems, methods of using emesis containment systems, and dissolvable charges for emesis containment systems.

In addition to being instinctively repulsive, vomit can carry contagions including the highly infectious norovirus and other pathogens. Therefore, it is typical to use emesis containers for containing vomit in airplanes, hospitals other medical settings, and personal settings, such as in the home or car to contain the mess from vomit during emesis. Conventional emesis containers range from simple bags (e.g., airplane “barf bags”) to more complex containment systems used in hospitals and other medical settings. A conventional emesis container includes a simple collapsable elongate plastic bag with a rigid ring around the neck of the bag near the opening. The ring has the dual purpose of holding the mouth of the bag open during use and providing a simple clip mechanism for closing the mouth of the bag after use. A limitation of this emesis container, however, is that the liquid vomit could be undesirably released from the bag due to puncturing or ripping of the bag or incomplete closure or reopening of the mouth. Even if the bag remains fully closed, odors from the vomit may still emanate from the bag.

Another conventional emesis container that addresses these limitations includes not only a similar collapsable elongate plastic bag with a rigid ring, but also includes a pouch filled with absorbent particles in a powder form disposed in a water-soluble pouch to absorb liquid from the vomit. The pouch dissolves within a few minutes of vomit being deposited in the bag so that the absorbent particles can absorb liquid from the vomit, which eventually reduces the chance of vomit being accidentally spilled from the bag and reduces odors emanating from the bag. However, vomit can still be spilled from the bag during the time needed for the pouch to dissolve and there is nothing to prevent the emanation of odors or pathogens, such as the novovirus, during use or before the pouch is either closed or the absorbent particles absorb the liquids from the vomit.

Therefore, it would be desirable to have a more effective containment system for liquids, gases, odors, and/or pathogens emanating from vomit discharged during an emesis event.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to emesis containment systems, methods of using emesis containment systems, and dissolvable charges for emesis containment systems.

According to a nonlimiting aspect, an emesis containment system includes a face mask with a discharge opening, a container for receiving vomit into an interior cavity, an air filter disposed adjacent a first opening into the container, a backflow barrier to inhibit passage of vomit out of the interior cavity through the discharge opening, and a dissolvable charge disposed inside the container. The dissolvable charge includes a surfactant that foams when contacted by liquid of the vomit.

According to another nonlimiting aspect, a method of containing emesis using an emesis containment system includes receiving a discharge of vomit into the interior cavity of a container during an emesis event through a discharge opening and backflow barrier, and forming with a surfactant a foam barrier on a top surface of the vomit inside the container to inhibit escape of gases from the vomit from the container.

According to yet another nonlimiting aspect, a dissolvable charge for an emesis containment system includes a dry pressed pellet having dry powder forms of a surfactant, absorbent particles, and a thickening agent pressed together. At least some of each of the surfactant, the absorbent particles, and the thickening agent is disposed on an exterior surface dry pressed pellet.

Technical aspects of systems, methods, and components having features as described above preferably include the ability to provide a more effective containment system for liquids, gases, odors, and/or pathogens emanating from vomit discharged during an emesis event than conventional emesis containers.

These and other aspects, arrangements, features, and/or technical effects will become apparent upon detailed inspection of the figures and the following description.

### BRIEF DESCRIPTION OF THE DRAWINGS

FIGS. 1 through 3 are diagrammatic illustrations of an emesis containment system at three different successive times in use according to a first nonlimiting embodiment of the invention.

FIG. 4 is a diagrammatic illustration of a dissolvable charge in the emesis containment system of FIGS. 1 through 3.

FIG. 5 is a perspective view of an emesis containment system according to a second nonlimiting embodiment of the invention.

FIG. 6 is a perspective view of a face mask of the emesis containment system of FIG. 5.

FIG. 7 is a perspective view of a backflow barrier of the emesis containment system of FIG. 5.

FIG. 8 is a perspective view of a filter ring of the emesis containment system of FIG. 5.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the emesis containment system during its use and/or as represented in the drawings. All such relative terms are useful to describe the illustrated embodiments but should not be otherwise interpreted as limiting the scope of the invention.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

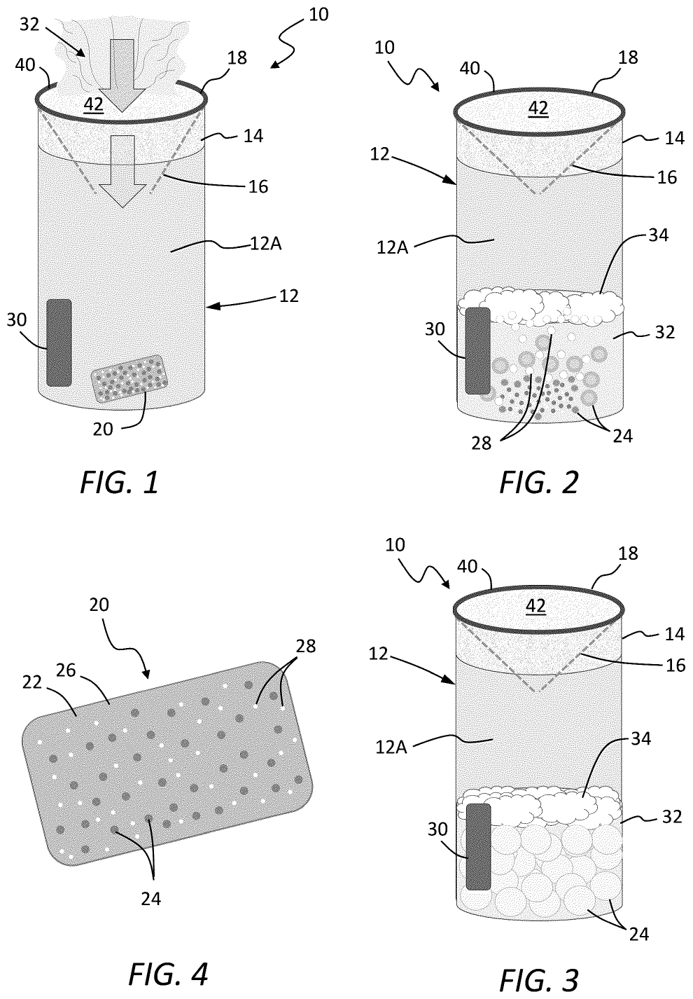

Turning now to FIGS. 1 to 3, a nonlimiting embodiment of an emesis containment system 10 is represented as including a container 12, a filter ring 14, a backflow barrier 16, a face mask 18, and a dissolvable charge 20 that provides one or more active ingredients for interacting with vomit 32 deposited inside the container 12. The emesis containment system 10 is intended to provide a convenient apparatus for containing vomit 32 and emissions from an emesis event, including not only solid and liquid matter of the vomit 32, but also gaseous emanations of the vomit 32. The dissolvable charge 20 provides the one or more active ingredients, which are preferably capable of absorbing and/or thickening liquids as well as creating a foam barrier 34 that inhibits the release of gases and associated odors from the container 12. The dissolvable charge 20 and its active ingredients are activated upon being contacted by vomit 32 during an emesis event, preferably immediately or soon after contact, to reduce the time frame during which liquids, gases, and/or aerosol particles could spill out of or otherwise escape from the containment system 10. The emesis containment system 10 may thereby also reduce the spread of odors, airborne pathogens, and/or aerosol particles that may emanate from the vomit 32 more quickly and/or more effectively than conventional emesis containers.

The container 12 is represented as having a main body 12A formed to have one or more liquid-impermeable sidewalls enclosing an interior cavity for securely containing vomit 32. The container 12 is preferably a pliable container, such as a lined paper bag or a flexible plastic bag. The sidewalls of the container 12 are substantially impermeable to water and other liquids that may be present in vomit so that the container 12 physically contains solid, liquid, and gaseous components of any vomit deposited therein without allowing seepage of liquids and gases therethrough. Suitable materials include those used for conventional emesis bags, typically a thin, flexible plastic film made from a commodity polymer such as polyethylene or polypropylene. However, other materials may be used for the container 12, including different flexible films and composite (laminated) structures (e.g., organic paper with a hydrophobic coating). The container material could also be clastic and able to stretch to contain the emesis volume. In this case, the container material itself could be elastic (e.g., synthetic rubber film) or the design of the container 12 could be modified to be expandable (e.g., with built-in ribbing like woven textiles or a mechanical bellows).

The face mask 18 is adapted to form an interface against a person's face surrounding the person's mouth and nose. The face mask 18 is preferably shaped to conform generally to an average human face (e.g., similar to a respirator mask) and to direct the flow of vomit 32 and air (exhalation) into the container 12. The face mask 18 has an outer peripheral engagement frame 40 with a discharge opening 42 surrounded by the engagement frame 40. The engagement frame 40 may be molded of a resiliently compliant material, such as rubbery plastic, to form a semi-compliant opening to seal against the user's face surrounding the mouth and nose with the discharge opening 42 aligned with the user's mouth. The discharge opening 42 is preferably of sufficient size to allow a stream of vomit 32 discharged from the user's mouth to freely flow therethrough during an emesis event. The discharge opening 42 may have gently tapered sidewall(s) that form a generally conical shape to funnel the vomit 32 into the interior cavity of the container 12. In one nonlimiting example, the face mask 18 is formed of thermoplastic polyurethane that is flexible and resistant to acid.

The backflow barrier 16 generally provides a baffle or other structure between the discharge opening 42 of the face mask 18 and the interior cavity of the container 12 so as to allow vomit 32 to pass from a user's mouth into the interior cavity but inhibit vomit 32 from passing back out of the interior cavity of the container 12 through the face mask 18. In this regard, the backflow barrier 16 may be viewed as functioning as a one-way check valve for the opening into the container and/or filter ring 14. The backflow barrier 16 is represented in FIGS. 1 through 3 as attached to the face mask 18 at or adjacent the discharge opening 42 and extending into the interior cavity of the container 12. One configuration for the backflow barrier 16 is a duck-bill valve that extends axially from the face mask 18 along the entire perimeter of the engagement frame 40 in order to protect the filter ring 14 from fluid flow during an emesis event. In the configuration of a duck-bill valve or similarly capable structure, the backflow barrier 16 also automatically closes to inhibit backflow (splash back) of vomit 32 during or after an emesis event.

The filter ring 14 is generally represented as a portion of the system 10 between the engagement frame 40 of the face mask 18 and the main body 12A of the container 12, in which case a lower end of the filter ring 14 is coupled to the main body 12A of the container 12 and surrounds an opening of the container 12 defined by the main body 12A. Additionally, the filter ring 14 may be considered an upper wall portion of the container 12. In either case, the filter ring 14 adjoins the discharge opening 42 to the container 12 and may be coupled directly to the engagement frame 40 of the face mask 18. At least a portion (and preferably the entirety) of the filter ring 14 is an air filter formed of a porous filtration material that forms a porous peripheral filter wall adjacent to and surrounding the discharge opening 42. If the container 12 is formed of a pliable material, such as a plastic bag, the filter ring 14 may also include a substantially rigid or resilient frame to expand the container 12 adjacent the discharge opening 42. The filter ring 14 controls air flow out of the container 12 by filtering the air (and the user's exhalation) that inherently exits the container 12 during emesis while the user's face is sealed against the engagement frame 40. The backflow barrier 16 is represented in FIGS. 1 through 3 as protruding entirely through the filter ring 14 and into the main body 12A of the container 12 so that vomit 32 introduced through the discharge opening 32 is conducted directly into the interior cavity of the container 12 instead of into a portion of the interior cavity of the container 12 surrounded by the filter ring 14. The porous filtration material of the filter ring 14 is preferably formed of a material capable of inhibiting if not preventing pathogens and/or aerosolized saliva from passing through the filter ring 14 while allowing air to pass through the filter ring 14. For example, the filtration material may be an N-95 type nonwoven filtration material. A hydrophobic coating may be formed on the inner surface of the filtration material.

The dissolvable charge 20 is disposed within the interior cavity of the container 12 so as to contact and interact with any vomit 32 deposited into the interior cavity of the container 12. As noted previously, the dissolvable charge 20 provides one or more active ingredients intended to interact with the vomit 32 to absorb liquids from the vomit 32, thicken any remaining unabsorbed liquids from the vomit 32, trap gases emitted by the vomit 32, and/or reduce the pathogenic properties of pathogens in the vomit 32. The dissolvable charge 20 is preferably in the form of a fast-dissolving pellet that will quickly dissolve (e.g., within less than about sixty seconds, and preferably within about thirty seconds or less upon exposure to a liquid of 4 pH or less) to allow the active ingredients to quickly interact with liquids in the vomit 32. A benefit of a pellet form is that it immediately places at least some of the active ingredients in direct contact of the vomit 32, thereby significantly reducing the time to obtain the desired results relative to conventional methods discussed previously herein. As schematically represented in FIG. 4, the dissolvable charge 20 may also include one or more fillers and/or binders 22 to create a stable pelletized form factor. The fillers and/or binders 22 may include, for example, corn starch and/or chitosan powder. A dissolvable charge 20 in the form of a fast-dissolving pellet may be formed by mixing the filler(s), binder(s), and active ingredients together in dry powder form and then mechanically pressing the dry powder together to form a dry pressed pellet.

As also schematically represented in FIG. 4, the dissolvable charge 20 preferably includes highly absorbent particles 24 (e.g., absorbent beads) in an amount capable of absorbing most if not all of the liquid in vomit 32 deposited into the interior cavity of the container 12. The absorbent particles 24 may be provided in the form of absorbent beads that expand when a liquid is absorbed thereby. The absorbent particles 24 preferably include cationic and anionic absorbent particles, which can be synthesized, for example, in conventional methods known for synthesizing chitosan-based and acrylamide-based hydrogel particles, respectively. Cationic particles are useful to provide greater fluid absorption capacities in low-pH environments (e.g., pH<6), such as typically found in vomit. Some benefits of using chitosan cationic particles are that they are nontoxic and can be naturally sourced (e.g., from crab shells). Acrylamide-based hydrogel particles are highly effective absorbents that have a variety of commercial uses in personal care (e.g., baby diapers), agriculture (e.g., soil amendments), and construction (e.g., internal curing agents).

The dissolvable charge 20 also preferably includes one or more thickening agents 26 that interact with and increase the viscosity of any liquids in the vomit 32 not otherwise absorbed by the absorbent particles 24. The thickening agent(s) 26 are preferably chosen to be able to interact with the remaining liquids to coat and contain vomit solids within a high-viscosity fluid, thereby further reducing the chance of spillage. A nonlimiting example of a suitable thickening agent is pectin.

The dissolvable charge 20 may further include one or more surfactants 28 that will foam upon interaction with liquids in the vomit 32. Foam formed from the interaction of the surfactant 28 and the vomit liquids preferably forms the aforementioned foam barrier (or “raft”) 34 on the top surface of the vomit 32 that helps to trap and/or contain gases from the vomit 32, thereby reducing the emission of odors and/or pathogens from vomit 32 inside the container 12. The surfactant 28 preferably also has an antiseptic quality, such as having anti-viral activity, to also reduce infectivity of any enveloped viruses, such as coronaviruses (SARS-COV-2), and non-enveloped viruses, such as norovirus. For example, anionic surfactants are best for disrupting phospholipid membranes, which form the protective envelope of some viruses (e.g., coronaviruses). The surfactant 28 preferably includes anionic surfactants and cationic surfactants. A suitable anionic surfactant is sodium lauryl sulfate (SLS). A suitable cationic surfactant is cetyltrimethylammonium bromide (CTAB). A nonlimiting example of a suitable mixture of such surfactants 28 includes a mixture of 0.2 g/L CTAB and 2.0 g/L SLS, which in some tests leading to the invention created the longest-lasting foam with a relatively large thickness in pH 4 HCl solutions. However, other suitable surfactant formulations could be used.

FIGS. 1 through 3 further represent the system 10 as including a pathogen sensor 30 disposed inside the container 12 to detect the presence of one or more pre-defined pathogens, such as specific viruses (e.g., norovirus, coronaviruses, flu viruses, rhinoviruses, etc.), pathogenic bacteria, and/or pathogenic fungi. The pathogen sensor 30 is represented as being in the form of a test strip within the interior cavity of the container 12, more particularly, disposed on and optionally embedded in an interior wall surface of the container 12, such that it will contact the vomit 32 deposited in the interior cavity. Alternatively, the material of the container 12 itself (or some portion thereof) may be chemically modified to change color upon detection of specific virus molecules. Physically integrated test strips and color-changing sensors that are specifically designed to detect low concentrations of viruses within emesis are preferably capable of automatically alerting individuals outside of traditional healthcare settings (e.g., sick individuals at home or on cruise ships) to the presence of harmful viruses within the emesis without the need for advanced testing and analysis provided by a certified healthcare professional.

FIGS. 1 through 3 also illustrate three successive stages in the process of using the emesis containment system 10 to contain vomit 32 and associated gases and pathogens during and after an emesis event. FIG. 1 illustrates a stage in which vomit 32 is discharged into the container 12 during an emesis event. During this stage, solids, liquids, and gases from the vomit 32 flow from the person into the interior cavity of the container 12 through the discharge opening 42 in the face mask 18. The backflow barrier 16 opens from the force of fluid and/or air flow from the user's mouth and/or nose, thereby allowing the vomit 32 to pass through the discharge opening 42 and into the interior cavity of the container 12. During the emesis event, air escapes the container 12 through the filter ring 14 and is filtered by the filtration material of the filter ring 14. From FIG. 1, it can be seen that the backflow barrier 16 is capable of inhibiting vomit 32 from flowing directly against the filtration material in the filter ring 14 as a result of the barrier 16 extending axially beyond the extent of the filter ring 14 within the container 12.

FIG. 2 illustrates a stage within a few seconds (e.g., two to sixty seconds) after discharge of the vomit 32 during the emesis event. The backflow barrier 16 is shown as having closed once fluid flow through the barrier 16 has ceased. Residual air flow escapes the container 12 through and is filtered by the filter ring 14. The vomit 32 comes into contact with the dissolvable charge 20 in the bottom of the container 12, causing it to quickly dissolve and separate. Because there is no barrier between the vomit 32 and the contents of the dissolvable charge 20, the active ingredients exposed on the exterior surface of the dissolvable charge 20 also immediately contact and activate when the vomit 32 contacts the exterior surface of the dissolvable charge 20. As the dissolvable charge 20 dissolves, the absorbent particles 24 begin to absorb liquid from the vomit 32 and begin to swell and increase in volume. The surfactants 28 dissolve and self-assemble at air/liquid interfaces, effectively trapping any emesis gases as bubbles and creating the foam barrier 34 that floats on the top surface of the vomit 32. The foam barrier 34 preferably completely caps the top surface of the vomit 32 inside the container 12, thereby trapping gases emitted from the vomit 32. This also prevents or at least reduces the escape of airborne pathogens from the vomit 32 out through the filter ring 14 or the discharge opening 42 of the face mask 18. The surfactants 28 may also act as an anti-viral agent to some viruses. The pathogen sensor 30 is in contact with the vomit 32 to detect and/or show the presence of whatever specific viruses it is designed to sense.

FIG. 3 illustrates a stage within a few minutes (e.g., one to thirty minutes) after the discharge of vomit 32 during the emesis event. The absorbent particles 24 continue swelling and absorbing free liquid of the vomit 32. Preferably, the absorbent particles 24 are present in an amount capable of absorbing most or substantially all of the liquid. The absorbent particles 24 thereby trap liquids from the vomit 32, preventing or at least reducing the risk that the trapped liquids can easily spill out of the container 12 in case of puncture or other opening. The viscosity of any residual liquid from the vomit 32 is increased by the thickening agent(s) 26 and/or fillers and/or binders 22. This higher viscosity residual liquid can then coat vomit solids, thereby further reducing the occurrence of any leaks or spills of liquids from the container 12. At the stage shown in FIG. 3, the liquid volume of the vomit 32 is now substantially or completely absorbed by the absorbent particles 24 or gelled by the thickening agent(s) 26. The foam barrier 34 is shown as entirely capping the vomit 32 held in the container 12 to act as a barrier to prevent or at least inhibit the escape of gases (including odors) from the vomit 32 contained in the container 12. The foam barrier 34 is preferably stable enough to form a barrier sufficient to prevent or at least reduce the emission of gases but weak enough to allow additional emesis to pass through the barrier 34, thereby allowing for capture of subsequent secondary emesis events. In some embodiments, the surfactants 28 in the foam barrier 34 and dissolved in the emesis liquid are able to reduce the infectivity of any viruses present in the emesis. After the emesis event is over, typically within thirty minutes, the container 12 may be closed and sealed and disposed of in an appropriate waste receptacle.

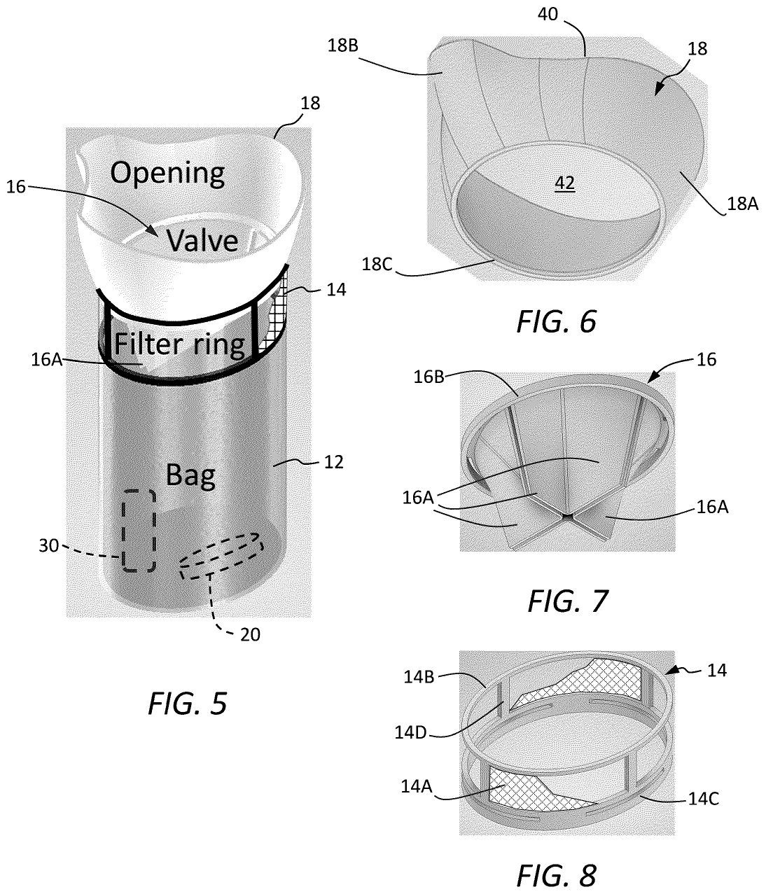

FIGS. 5 through 8 show a nonlimiting example of another embodiment of the emesis containment system 10. In this embodiment, the container 12 is in the form of a pliable (e.g., foldable and/or crushable) plastic bag having a closed lower end and an opening at an open upper end. In FIG. 8, the filter ring 14 is represented as having a filtration material 14A (partially shown) between and supported by upper and lower rings 14B and 14C that are axially spaced apart and connected by support struts 14D. The rings 14B and 14C and struts 14D define a frame of the filter ring 14. The filtration material 14A forms a sidewall of the filter ring 14 that covers openings between the upper and lower rings 14B and 14C and between adjacent pairs of the struts 14D. In FIG. 5, the open upper end of the container 12 is attached to the lower ring 14C of the filter ring 14 such that the filter ring 14 secures the open upper end of the container 12 in an open position.

In FIG. 7, the backflow barrier 16 is represented in the form of a duck-bill valve with four flaps 16A extending axially downwardly from a peripheral flange 16B. FIG. 7 shows the backflow barrier 16 in a closed configuration in which the flaps 16A are in the shape of a cross and span the entire interior space of the barrier 16 surrounded by the flange 14B. In FIG. 5, the upper ring 14B of the filter ring 14 is coupled to the peripheral flange 16B of the backflow barrier 16 and the flaps 16A of the backflow barrier 16 extend axially downwardly through the filter ring 14 and into the mouth of the container 12.

In FIG. 6, the face mask 18 is represented as having a funnel portion 18A extending from the face-fitting engagement frame 40 with an axially aligned nose receiver 18B disposed along a portion of the engagement frame 40 and the funnel portion 18A. In FIG. 5, the lowermost narrow end 18C of the funnel portion 18A is attached to the peripheral flange 16B of the backflow barrier 16 such that the nose receiver 18B is facing away from the backflow barrier 16, and thereby toward the nose and face of a user. The face mask 18 preferably has a face-fitting shape, such as an N-95-style shape, and its funnel portion 18B defines a large discharge opening 42.

FIG. 5 further represents the container 12 as equipped with the aforementioned pathogen sensor 30 and dissolvable charge 20, the former represented in the form of a test strip located on an inner wall of the container 12 adjacent its closed lower end and the latter represented in the form of a dry-pressed pellet disposed in the interior cavity of the container 12.

The emesis containment systems 10 disclosed herein are believed to have one or more advantages over conventional emesis containers. For example, preferred (but not all) embodiments of the emesis containment systems 10 may contain up to 1 L of vomit, generally as a mixture of solids, liquids, and gases that typically ranges in pH from 1.5-6. The emesis containment systems 10 also preferably contain ingredients that coat and absorb the solid, liquid, and gaseous emesis components to prevent or at least reduce the risk of spillage of emesis and to reduce the spread of gases and aerosolized particles which may contain viruses. The emesis containment systems 10 may also contain antiviral ingredients that can reduce or eliminate virus infectivity to reduce the spread of viruses during and after an emesis event, and may contain sensor technology that can detect the presence of harmful viruses within the emesis. Other benefits are also foreseeable.

As previously noted above, though the foregoing detailed description describes certain aspects of one or more particular embodiments of the invention, alternatives could be adopted by one skilled in the art. For example, the emesis containment system 10 and its components could differ in appearance and construction from the embodiments described herein and shown in the drawings, functions of certain components of the emesis containment system 10 could be performed by components of different construction but capable of a similar (though not necessarily equivalent) function, and various materials could be used in the fabrication of the emesis containment system 10 and/or its components. As such, and again as was previously noted, it should be understood that the invention is not necessarily limited to any particular embodiment described herein or illustrated in the drawings.

1. An emesis containment system comprising:
a face mask with a discharge opening;
a container for receiving vomit into an interior cavity thereof, the container having a first opening aligned with the discharge opening;
an air filter disposed adjacent the first opening into the container;
a backflow barrier configured to allow passage of vomit into the interior cavity of the container from the discharge opening and to inhibit passage of vomit out of the interior cavity through the discharge opening; and
a dissolvable charge disposed inside the container, wherein the dissolvable charge comprises a surfactant that foams when contacted by liquid of the vomit.

2. The emesis containment system of claim 1, wherein the dissolvable charge comprises an anionic surfactant.

3. The emesis containment system of claim 2, wherein the anionic surfactant comprises sodium lauryl sulfate.

4. The emesis containment system of claim 1, wherein the dissolvable charge comprises a cationic surfactant.

5. The emesis containment system of claim 4, wherein the cationic surfactant comprises cetyltrimethylammonium bromide.

6. The emesis containment system of claim 1, wherein the dissolvable charge comprises absorbent particles that absorb the liquid of the vomit.

7. The emesis containment system of claim 6, wherein the absorbent particles comprise absorbent beads.

8. The emesis containment system of claim 1, wherein the dissolvable charge comprises a thickening agent that increases the viscosity of the liquid of the vomit.

9. The emesis containment system of claim 1, wherein the dissolvable charge is in the form of a fast-dissolving pellet comprising dry powder forms of the surfactant, absorbent particles, and a thickening agent pressed together in a dry pressed pellet.

10. The emesis containment system of claim 1, wherein the air filter comprises a filter ring disposed between the face mask and to the container.

11. The emesis containment system of claim 1, wherein the backflow barrier is located between the discharge opening and the air filter to inhibit vomit discharged through the discharge opening into the interior cavity from hitting the air filter.

12. The emesis containment system of claim 1, wherein the backflow barrier comprises a duck-bill check valve.

13. The emesis containment system of claim 1, further comprising a pathogen sensor disposed inside the container to detect the presence of a pre-selected pathogen in vomit.

14. A method of containing emesis using an emesis containment system, the emesis containment system comprising a face mask with a discharge opening, a container for receiving vomit into an interior cavity thereof, a backflow barrier configured to allow passage of vomit into the interior cavity of the container from the discharge opening and to inhibit passage of vomit out of the interior cavity through the discharge opening, and a dissolvable charge disposed inside the container, wherein the dissolvable charge comprises a surfactant that foams when contacted by liquid of the vomit, the method comprising:
receiving a discharge of vomit into the interior cavity of the container during an emesis event through the discharge opening and the backflow barrier; and
forming with the surfactant a foam barrier on a top surface of the vomit inside the container to inhibit escape of gases from the vomit from the container.

15. The method of claim 14, further comprising reducing the infectivity of viruses in the vomit with the surfactant.

16. The method of claim 14, further comprising absorbing liquid in the vomit with absorbent particles carried by the dissolvable charge.

17. The method of claim 14, further comprising increasing the viscosity of liquid in the vomit with a thickening agent carried by the dissolvable charge.

18. The method of claim 14, further comprising sensing the presence of a pre-selected pathogen in the vomit with a pathogen sensor disposed inside the container.

19. A dissolvable charge for an emesis containment system, the dissolvable charge comprising:
a dry pressed pellet comprising dry powder forms of a surfactant, absorbent particles, and a thickening agent pressed together,
wherein at least some of each of the surfactant, the absorbent particles, and the thickening agent is disposed on an exterior surface of the dry pressed pellet.

20. The dissolvable charge of claim 19, wherein the dry pressed pellet further comprises dry powder filler.
